(19) United States
(12) Patent Application Publication
(10) Pub. No.: US 2005/0280368 A1
(43) Pub. Date: Dec. 22, 2005

(54) Plasma display panel (PDP)

(76) Inventor: Jung-Keun Ahn, Suwon-si (KR)

Correspondence Address: Robert E. Bushnell, Suite 300, 1522 K Street, N.W., Washington, DC, 20005, US

(21) Appl. No.: 11/153,423

(22) Filed: Jun. 16, 2005

(30) Foreign Application Priority Data
Jun. 18, 2004 (KR) 10-2004-0045488

(51) Int. Cl. H01J 17/49

(52) U.S. Cl. 313/582; 313/585; 313/586

(57) ABSTRACT

A Plasma Display Panel (PDP) capable of increasing an aperture ratio and stabilizing discharge by using only metal electrodes includes: first and second substrates facing each other; address electrode arranged between the first and second electrodes; barrier ribs arranged between the first and second electrodes to define a plurality of discharge cells; phosphor layers arranged on inner surfaces of the discharge cells; and first and second electrodes arranged between the first and second electrodes in a direction intersecting the address electrodes to face each other to form discharge gaps in the discharge cells, wherein each of the first and second electrodes includes at least three lines separated from each other by predetermined intervals, and wherein sizes of first gaps between pairs of lines arranged near edges of the discharge cells are different from sizes of second gaps between lines arranged near the discharge gaps.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on 18 Jun. 2004 and there duly assigned Serial No. 10-2004-0045488.

### BACKGROUND OF THE INVENTION

1. Field of the Invention

The present invention relates to a Plasma Display Panel (PDP), and more particularly, to a PDP capable of increased brightness due to an improved electrode structure.

2. Description of the Related Art

A plasma display panel (PDP) comprises discharge cells provided between a pairs of glass substrates and pairs of sustain electrodes corresponding to the discharge cells. The PDP displays an image by using visible light emitting from phosphor layers excited by ultraviolet light generated during a plasma discharge.

In general, in order not to block light emitted from the substrate, display electrodes are transparent. However, since transparent electrodes have a high resistance, metal electrodes are affixed to the transparent electrodes in order to compensate for the high resistance thereof.

The transparent electrodes are made of Indium Tin Oxide (ITO) or SnO₂. The metal electrodes are made of Ag or a thin film having a triple layered structure of Cr/Cu/Cr or a double layered structure of Al/Cr.

These electrode structures are formed by disposing the metal electrodes on the glass substrate with photo etching and lift-off methods, and then, disposing the transparent electrodes with photo etching and lift-off methods.

Therefore, the process of forming the electrode structures is complicated, so that the production cost of the PDP increases. In addition, the transparent electrodes are very expensive, also increasing the production cost of the PDP.

Therefore, techniques for forming the display electrodes by not using transparent electrodes but rather using metal electrodes have been researched and developed. One of the techniques is discussed in U.S. Pat. No. 6,522,072, entitled “Plasma Display Panel”.

According to U.S. Pat. No. 6,522,072, the production cost of the PDP can be reduced in comparison to the PDP having the aforementioned electrode structure. However, since the display electrodes are formed with only metal electrodes, there is a problem in that the brightness of the PDP decreases due to a decrease in the aperture ratio thereof.

In order to solve the problem, another technique for lengthening a distance between two metal electrodes by interposing a discharge gap therebetween has been proposed. However, this technique has a problem in that the discharge voltage increases and the discharge is unstable. Therefore, there is a need for an improvement thereof.

### SUMMARY OF THE INVENTION

An object of the present invention is to provide a Plasma Display Panel (PDP) having an increased aperture ratio and a stabilized discharge using only metal electrodes.

In order to achieve the object, according to one aspect of the present invention, a Plasma Display Panel (PDP) is provided comprising: first and second substrates facing each other; address electrodes arranged between the first and second substrates; barrier ribs arranged between the first and second substrates to define a plurality of discharge cells; phosphor layers arranged on inner surfaces of the discharge cells; and first and second electrodes arranged between the first and second substrates in a direction intersecting the address electrodes to face each other to form discharge gaps in the discharge cells; wherein each of the first and second electrodes comprises at least three lines separated from each other by predetermined intervals, and wherein sizes of first gaps between pairs of lines arranged near edges of the discharge cells are different from sizes of second gaps between lines arranged near the discharge gaps.

The second gaps are preferably larger than the first gaps.

Each of the first and second electrodes preferably comprises: a first line arranged near the edge of the discharge cell; a second line arranged to form the discharge gap; and a third line interposed between the first and second lines; and each of the first and second electrodes preferably further comprises a connection line adapted to connect the first, second, and third lines in a transverse direction thereof.

The connection lines are preferably arranged along a longitudinal central line of the discharge cell.

Each of the first and second electrodes preferably further comprises a protrusion protruding from an intersection of one of the connection lines and the second line toward the third line.

The protrusion portion preferably has an angled or rounded shape.

The first, second, and third lines are preferably parallel to each other.

The first and second electrodes are preferably arranged to face each other in the discharge cell to form first and second discharge gaps having different sizes.

The second discharge gap is preferably arranged at an intersection of one of the connection lines and the second line; and the second discharge gap is preferably larger than the first discharge gap.

The first and second electrodes preferably comprise metal electrodes.

According to another aspect of the present invention, a Plasma Display Panel (PDP) is provided comprising: first and second substrates facing each other; address electrodes arranged between the first and second electrodes; barrier ribs arranged between the first and second substrates to define a plurality of discharge cells; phosphor layers arranged on inner surfaces of the discharge cells; and first and second electrodes arranged between the first and second substrates in a direction intersecting the address electrodes to face each other to form discharge gaps in the discharge cells; wherein each of the first and second electrodes comprises: at least a pair of lines and a connection line adapted to connect the pair of lines separated from each other by predetermined intervals; and a protrusion protruding from an intersection of the connection line and the lines.

Each of the first and second electrodes preferably comprises a first line arranged near the edge of the discharge cell and a second line arranged near the central portion of the discharge cell, and the protrusion preferably protrudes from the second line toward the first line.

The protrusion portion has an angled or rounded shape.

According to yet another aspect of the present invention, a Plasma Display Panel (PDP) is provided comprising: first and second substrates facing each other; address electrodes arranged between the first and second substrates; barrier ribs arranged between the first and second substrates to define a plurality of discharge cells; phosphor layers arranged on inner surfaces of the discharge cells; and first and second electrodes arranged between the first and second electrodes in a direction intersecting the address electrodes to face each other to form discharge gaps in the discharge cells; wherein each of the first and second electrodes comprises at least three lines separated from each other by predetermined intervals; and wherein sizes of first gaps between pairs of lines arranged near central portions of the discharge cells are different from sizes of second gaps between pairs of lines arranged near edges of the discharge cell.

The second discharge gaps are preferably larger than the first discharge gaps; and the second discharge gaps are preferably disposed along central lines of the discharge cells.

### BRIEF DESCRIPTION OF THE DRAWINGS

The above and other features and advantages of the present invention will become more apparent by describing in detail exemplary embodiments thereof with reference to the attached drawings in which:

FIG. 1 is a partially exploded perspective view of a Plasma Display Panel (PDP) according to a first embodiment of the present invention;

FIG. 2 is a plan view of an arrangement of barrier ribs and electrodes of the PDP according to the first embodiment of the present invention;

FIG. 3 is a plan view of an arrangement of barrier ribs and electrodes of a PDP according to of a second embodiment of the present invention;

FIG. 4 is a plan view of an arrangement of barrier ribs and electrodes of a PDP according to of a third embodiment of the present invention;

FIG. 5 is a modified example of the PDP according to the third embodiment of the present invention; and

FIG. 6 is a view of a distribution of brightness in one discharge cell.

### DETAILED DESCRIPTION OF THE INVENTION

Exemplary embodiments of the present invention are described in detail below with reference to the accompanying drawings. It should be noted that the present invention is not limited to these exemplary embodiments.

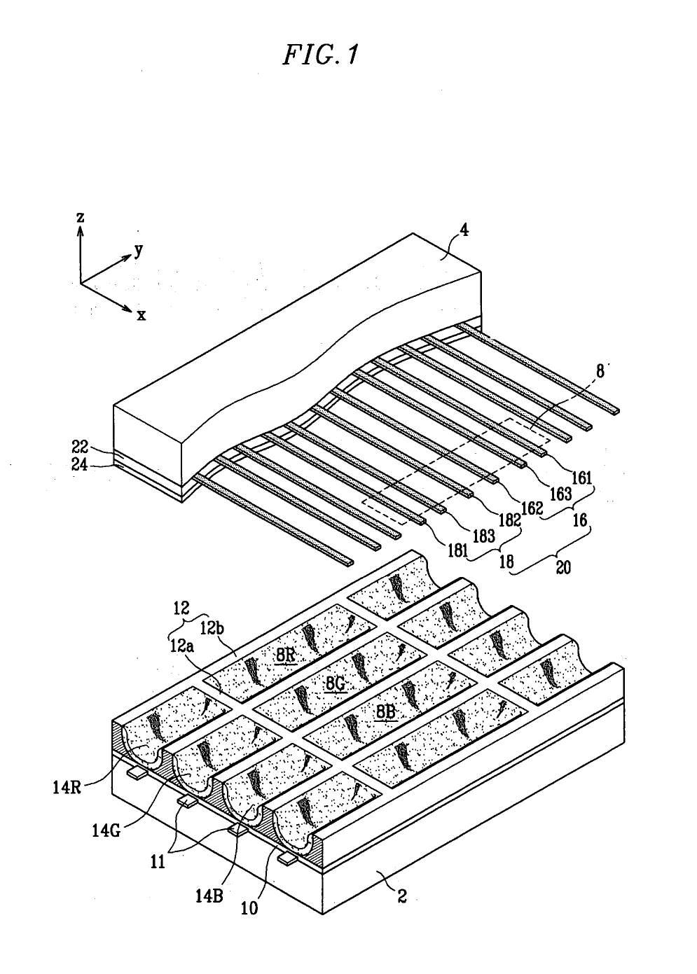

FIG. 1 is a partially exploded perspective view of a plasma display panel (PDP) according to a first embodiment of the present invention. The PDP comprises a pair of glass substrates 2 and 4 facing each other in a predetermined distance. A plurality of barrier ribs 12 are disposed to define red, green, and blue discharge cells 8R, 8G, and 8B. Address electrodes 11 are preferably disposed under the discharge cells 8R, 8G, and 8B to extend along the longitudinal central line (Y direction) of the discharge cells 8R, 8G, and 8B. The address electrodes 11 are separated from each other in a predetermined interval.

The address electrodes 11 are disposed on an inner surface of the glass substrate 2 to extend in the Y direction. A dielectric layer 10 is disposed on the entire inner surface of the glass substrate 2 to cover the address electrodes 11.

The barrier ribs 12 are disposed on the dielectric layer 10. Red, green, and blue phosphor layers 14R, 14G, and 14B are coated on the walls of the barrier ribs 12 and the exposed dielectric layer 10 in the discharge cells 8R, 8G, and 8B, respectively. The barrier ribs 12 are interposed between the address electrodes 11.

In FIG. 1, the barrier ribs 12 are constructed with first and second barrier rib elements 12a and 12b extending in the X and Y directions, respectively, so that the discharge cells 8R, 8G, and 8B are arrayed in a matrix structure. However, the arrangement of the discharge cells is not limited to the matrix structure. For example, the discharge cells can be arrayed in a stripe structure with only the second barrier rib elements 12b being disposed parallel to each other. In addition, the discharge cells can be arrayed in a delta structure, where the discharge cells have a triangular shape.

Display electrodes 20 are disposed on the glass substrate 4 (facing the glass substrate 2) in the direction (X direction) perpendicular to the address electrodes 11. The display electrodes 20 include scan electrodes 16 and sustain electrode 18. A dielectric layer 22 and an MgO protective layer 24 are sequentially disposed on an inner surface of the glass substrate 4 to cover the display electrodes 20.

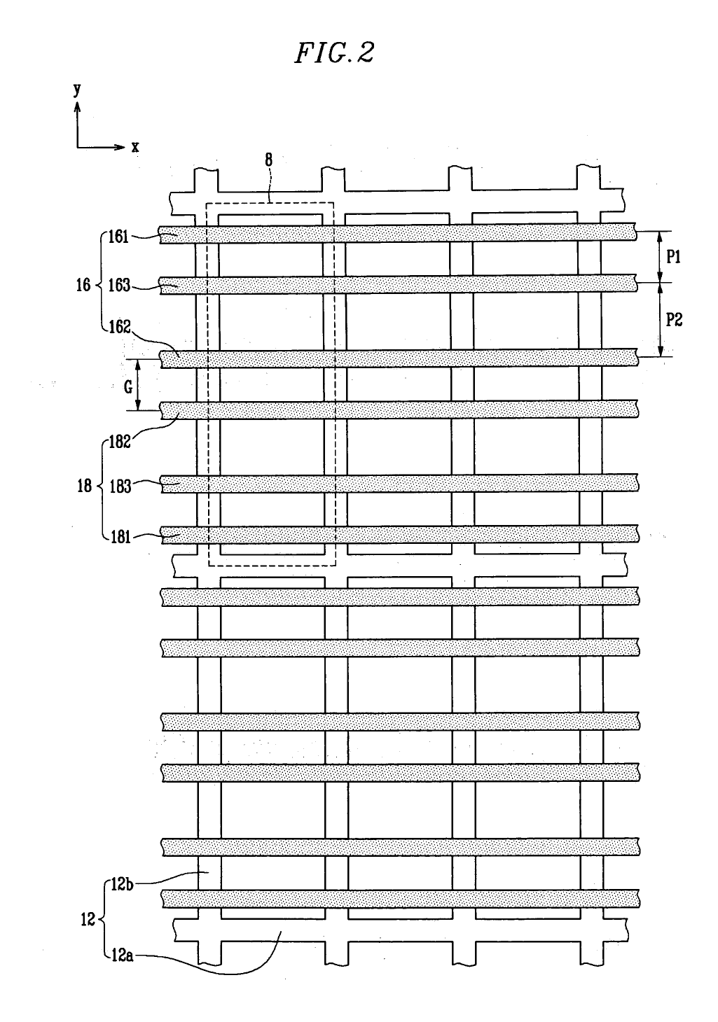

In the embodiment, the display electrodes 20 are made of only a conductive material such as metal. Each of the display electrodes 20 includes at least three lines separated from each other in a predetermined interval. The electrode structure according to the embodiment is described below in detail with reference to FIG. 2.

The discharge cells 8R, 8G, and 8B are disposed at positions corresponding to intersections of the address electrodes 11 and the display electrodes 20. The discharge cells are filled with a discharge gas for generating a plasma discharge and emitting ultraviolet (UV) light. The discharge gas is mainly a mixture of Ne and Xe

In the PDP according to the present invention, a reset discharge is generated between the display electrodes 20 to reset charges in the discharge cells. Next, an address voltage is supplied between the address electrodes 11 and the scan electrodes 16 to generate a wall charge, so that discharge cells for displaying an image can be selected. After the discharge cells have been selected, a discharge sustain voltage is supplied to the display electrode 20 to display the image.

In the embodiment, the display electrodes are not formed using transparent electrodes but rather are formed using metal electrodes.

FIG. 2 is a plan view of an arrangement of barrier ribs and electrodes of the PDP according to the first embodiment of the present invention. Although the barrier ribs are constructed in a matrix structure, the present invention is not limited thereto. The description below is with respect to the matrix structure.

Referring to FIG. 2, the scan electrodes 16 and the sustain electrodes 18 constituting the display electrodes 20 are disposed in the direction intersecting the address electrodes 11. The scan electrodes 16 and the sustain electrodes 18 face each other to form discharge gaps G in the discharge cells 8. The scan electrode 16 and the sustain electrode 18 comprise: first lines 161 and 181 disposed in the vicinity of the discharge cells 8; second lines 162 and 182 disposed to form the discharge gap G; and third lines 163 and 183 interposed between the first lines 161 and 181 and the second lines 163 and 183.

The second lines 162 and 182 facing each other to form the discharge cell 8 generate a facing discharge at the beginning of the plasma discharge according to voltages supplied to the electrodes.

The third lines 163 and 183 have a function of inducing the initial discharge generated between the second lines 162 and 182 of each electrode to the edge of the discharge cell 8. Since an electric field for generating the discharge is inversely proportional to a distance between the first lines 161 and 181 and the second lines 162 and 182, if the distance is too long, the initial discharge generated across the discharge gap G cannot spread. Therefore, in the embodiment, the aforementioned third lines 163 and 183 are interposed between the first lines 161 and 181 and the second lines 162 and 182 to reduce the distances between the electrodes, that is, the effective distance between the first lines 161 and 181 and the second lines 162 and 182, so that it is possible for the discharge to easily spread.

In the embodiment, a first gap P1 between the first line 161 and the third line 183 is designed to be larger than a second gap P2 between the second line 162 and the third line 183 in consideration of a strong discharge occurring at the center of the discharge cell 8. Therefore, by increasing the aperture ratio of the region near the center of the discharge cells, it is possible to prevent a decrease in brightness of PDP due to an arrangement of non-transparent metal electrodes.

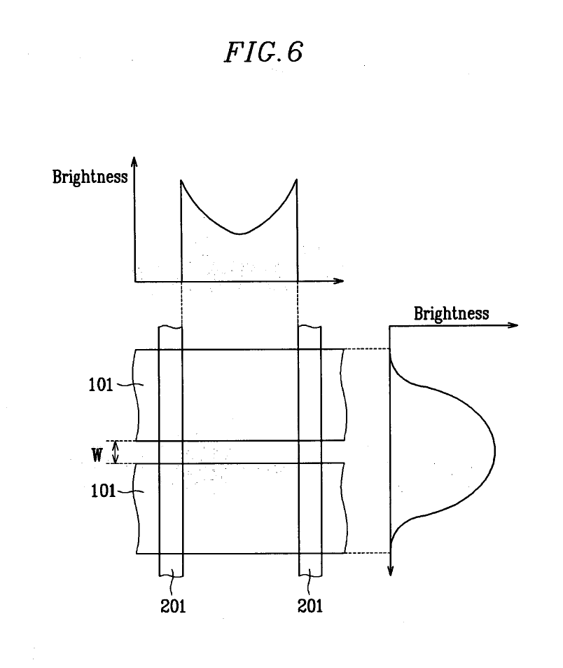

As described above with reference to FIG. 6 discussed below, the brightness has the strongest distribution at regions near the discharge gaps. By widening the gap between the second lines 162 and 182 and the third lines 163 and 183 disposed at the regions, the light 11 generated at the interior of the discharge cells is not blocked by the non-transparent electrodes to emit from the PDP.

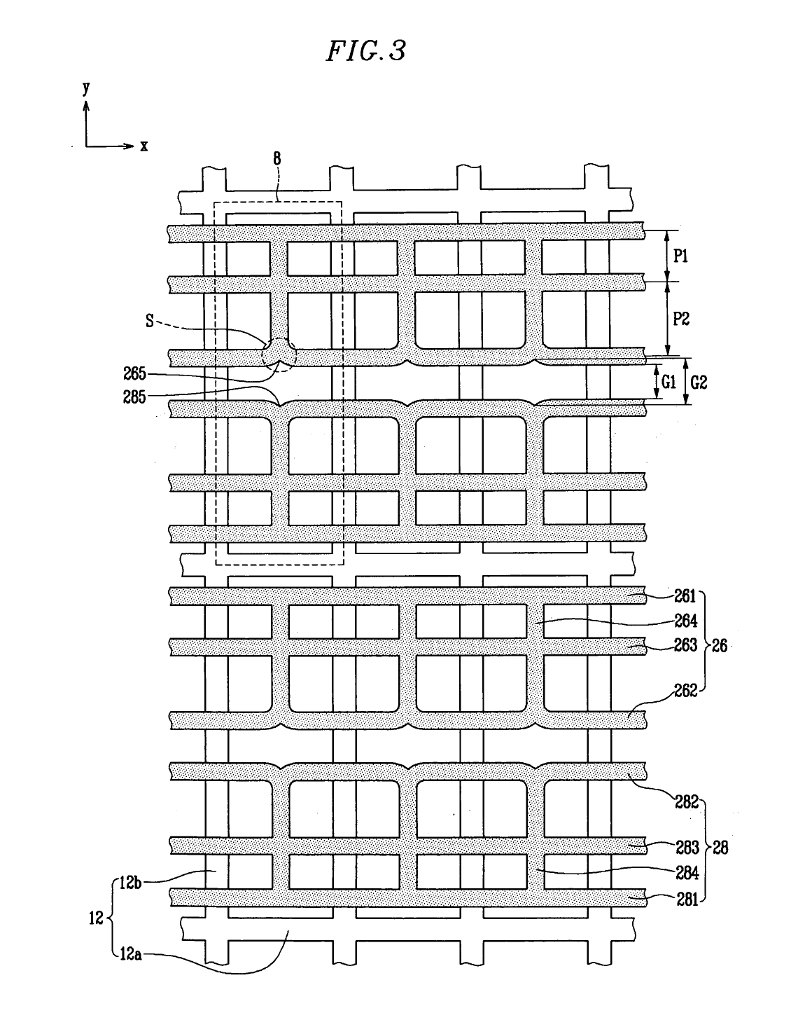

FIG. 3 is a plan view of an arrangement of barrier ribs and electrodes of a PDP according to of a second embodiment of the present invention.

In the PDP according to the embodiment, scan electrodes 26 and sustain electrodes 28 constituting display electrodes are disposed to be separated from each other by a predetermined interval. In addition, the scan electrodes 26 and the sustain electrodes 28 comprise first lines 261 and 281, second lines 262 and 282, and third lines 263 and 283.

In the embodiment, connection lines 264 and 284 are provided to connect the first lines 261 and 281, the second lines 262 and 282, and the third lines 263 and 283 in the transverse direction thereof.

The connection lines 264 and 284 are disposed along the longitudinal central line of the discharge cell 8 to distribute the discharge uniformly over the entire discharge cell 8. The connection lines 264 and 284 are made of the same material as the first and third lines. The connection lines 264 and 284 are preferably provided to all the discharge cells 8.

By providing the connection lines 264 and 284 to connect the first, second, and third lines, the initial discharge generated in the discharge gaps G between the second lines 262 and 282 of the electrodes move along the connection lines 264 and 284 to spread toward the first lines 261 and 281. As a result, it is possible to easily generate a long gap discharge.

In addition, by providing the connection lines 264 and 284, if there is any disconnection in a line, the other lines can serve to replace the disconnected line. Therefore, where there is a problem due to a disconnection of electrodes, it is possible to maintain light emitting efficiency and brightness of the PDP.

In the embodiment, discharge gaps between the scan electrodes 26 and the sustain electrodes 28 comprise a first discharge gap G1 and a second discharge gap G2. The first discharge gap G1 is shorter than the second discharge gap G2. Particularly, the second discharge gaps G2 are preferably disposed at intersections of the connection lines 264 and 284 and the second lines 262 and 282. As a result, the discharge initiated from the first discharge gap G1 can easily spread through the connection lines 264 and 284 as the long gap discharge between the first lines 261 and 281.

As an example of forming the second discharge gaps G2, recess portions 265 and 285 can be formed to face each other at the intersections S as shown in FIG. 3.

Similar to the first embodiment, in this embodiment, a first gap P1 between the first line 261 and the third line 283 is larger than a second gap P2 between the second line 262 and the third line 283

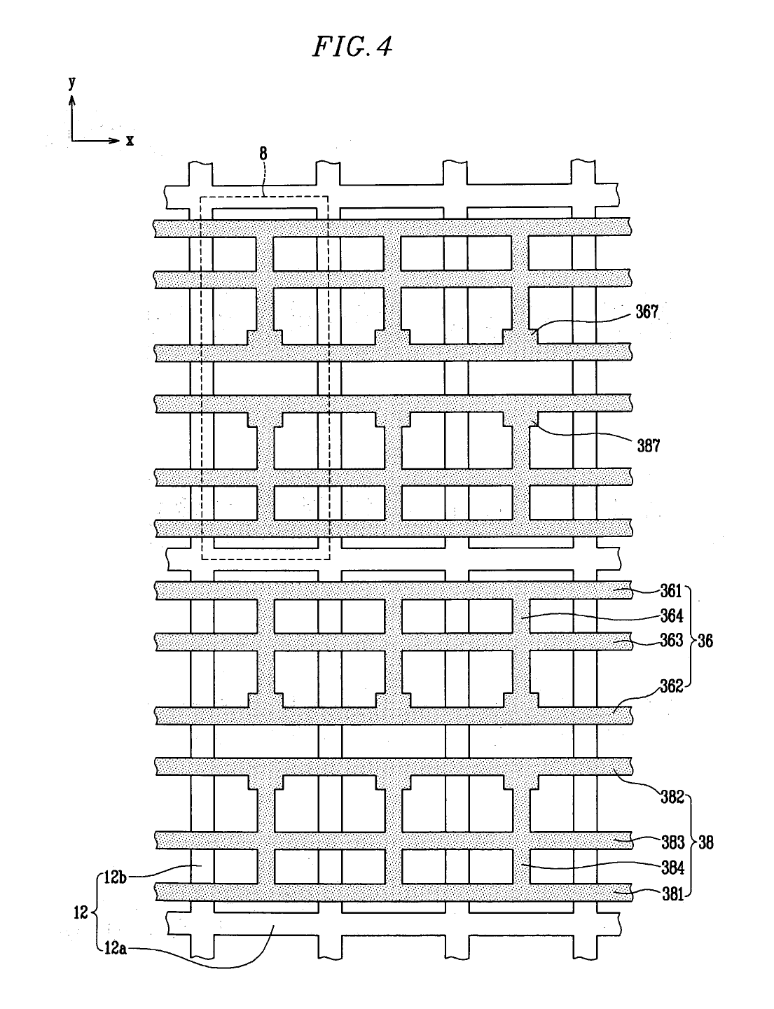

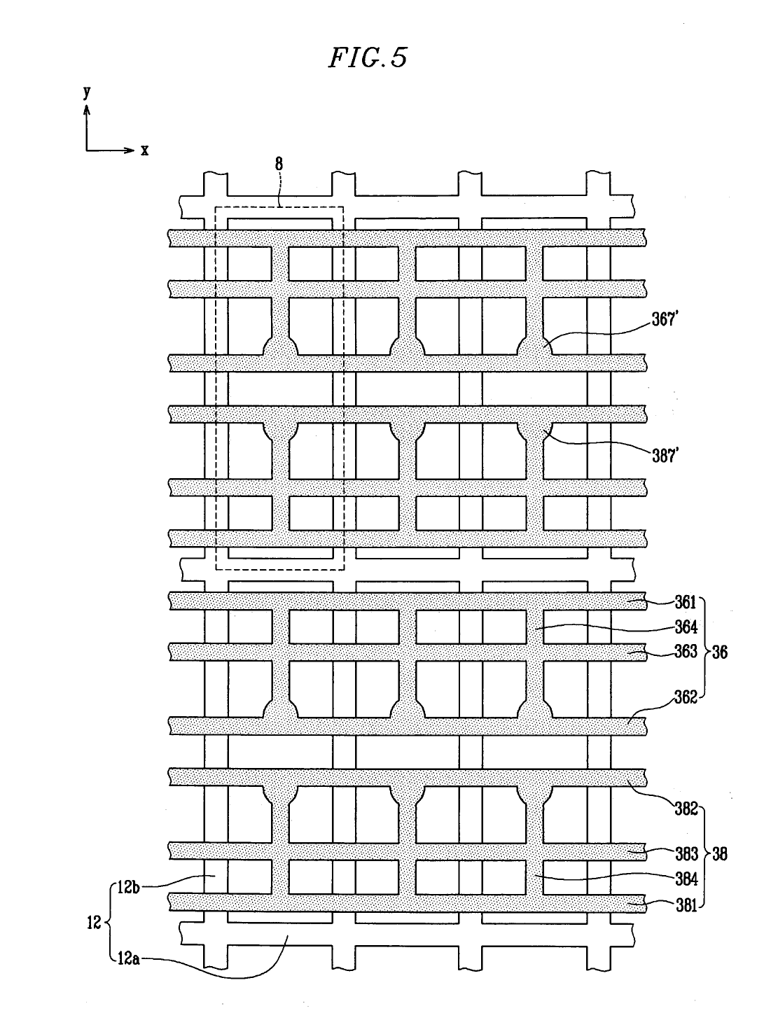

FIG. 4 is a plan view of an arrangement of barrier ribs and electrodes of a PDP according to of a third embodiment of the present invention. FIG. 5 is a modified example of the PDP according to the third embodiment of the present invention.

In the PDP according to this embodiment, scan electrodes 36 and sustain electrodes 38 constituting display electrodes are disposed to be separated from each other by a predetermined interval. In addition, the scan electrodes 36 and the sustain electrodes 38 comprise first lines 361 and 381, second lines 362 and 382, and third lines 363 and 383.

In this embodiment, the scan electrodes 38 and the sustain electrodes 38 further comprise protrusion portions 367 and 387 protruding from interactions of the second lines 382 and 382 and the connection lines 364 and 384, so that it is possible to more easily spread the discharge. As a result, the intervals between the second lines 382 and 382 and the third lines 383 and 383 can be widened, so that it is possible to increase brightness of the PDP greatly.

More specifically, in this embodiment, each of the scan electrodes 36 and the sustain electrodes 38 comprises the protrusion portion 367 and 387 protruding from the intersection of the second lines 362 and 382 and the connection lines 364 and 384 to extend area of the electrodes toward the first lines 361 and 381. Therefore, when the initial discharge is generated between the second lines 362 and 382, charges are accumulated on the second lines 362 and 382 and the intersections of the second lines 362 and 382 and the connection lines 364 and 384. Particularly, a relatively large number of charges are accumulated on the protrusion portions 367 and 387. In addition, since the protrusion portions 367 and 387 protrude from regions near the protrusion portions 367 and 387 toward the third lines 363 and 383, it is possible to effectively reduce the gaps between the second lines 362 and 382 and the third lines 363 and 383. As a result, it is possible to easily spread the discharge initiated from the second lines 362 and 382 toward the first lines 361 and 381 and the third lines 363 and 383.

It has been empirically validated that the most stable discharge can spread in a PDP with a discharge-cell transverse pitch of 1,110 μm, a discharge gap of 90 μm, and a gap between the second and third lines of 110˜120 μm. However, in this embodiment, since the gap between the second and third lines can be widened up to 140˜150 μm, light generated by regions near the discharge gap is not blocked, so that it is possible to increase the brightness of the PDP.

The protrusion portions 367 and 387 can have an angled shape as shown in FIG. 4. In addition, the protrusion portions 367 and 387 can have a rounded shape as shown in FIG. 5.

FIG. 6 is a view of a distribution of brightness in one discharge cell of PDP. The following features can be understood from the distribution of brightness.

In the FIG. 6, only the display electrodes 101 and barrier ribs 201 are selectively depicted. The upper graph shows a distribution of brightness along the display electrode, and the left graph shows a distribution of brightness along the barrier rib. It can be understood from the two graphs that the brightness has a Gaussian distribution with respect to the discharge gap W. Namely, it can be understood that the discharge intensity in a vicinity of the discharge gap is larger than in other regions.

According to the present invention, it is possible to reduce production cost of a PDP in comparison to a PDP having conventional transparent electrodes. In addition, since an intensity of sustain discharge increases, it is possible to reduce a driving voltage for the sustain discharge. In addition, since a blocked area of the discharge gap (where the brightness is concentrated) is minimized, it is possible to increase the brightness of PDP. In addition, since an interval between a pair of electrode lines disposed near the discharge gap can be further widened, it is possible to stably spread the discharge.

While the present invention has been particularly shown and described with reference to exemplary embodiments thereof, it will be understood by those skilled in the art that various modifications in form and detail can be made therein without departing from the spirit and scope of the present invention as defined by the appended claims.

1. A Plasma Display Panel (PDP), comprising:
first and second substrates facing each other;
address electrodes arranged between the first and second substrates;
barrier ribs arranged between the first and second substrates to define a plurality of discharge cells;
phosphor layers arranged on inner surfaces of the discharge cells; and
first and second electrodes arranged between the first and second substrates in a direction intersecting the address electrodes to face each other to form discharge gaps in the discharge cells;
wherein each of the first and second electrodes comprises at least three lines separated from each other by predetermined intervals, and
wherein sizes of first gaps between pairs of lines arranged near edges of the discharge cells are different from sizes of second gaps between lines arranged near the discharge gaps.

2. The plasma display panel of claim 1, wherein the second gaps are larger than the first gaps.

3. The PDP of claim 1, wherein each of the first and second electrodes comprises:
a first line arranged near the edge of the discharge cell;
a second line arranged to form the discharge gap; and
a third line interposed between the first and second lines; and
wherein each of the first and second electrodes further comprises a connection line adapted to connect the first, second, and third lines in a transverse direction thereof.

4. The PDP of claim 3, wherein the connection lines are arranged along a longitudinal central line of the discharge cell.

5. The PDP of claim 3, wherein each of the first and second electrodes further comprises a protrusion protruding from an intersection of one of the connection lines and the second line toward the third line.

6. The PDP of claim 5, wherein the protrusion portion has an angled or rounded shape.

7. The PDP of claim 3, wherein the first, second, and third lines are parallel to each other.

8. The PDP of claim 3, wherein the first and second electrodes are arranged to face each other in the discharge cell to form first and second discharge gaps having different sizes.

9. The PDP of claim 8, wherein the second discharge gap is arranged at an intersection of one of the connection lines and the second line; and wherein the second discharge gap is larger than the first discharge gap.

10. The PDP of claim 1, wherein the first and second electrodes comprise metal electrodes.

11. A Plasma Display Panel (PDP), comprising:
first and second substrates facing each other;
address electrodes arranged between the first and second electrodes;
barrier ribs arranged between the first and second substrates to define a plurality of discharge cells;
phosphor layers arranged on inner surfaces of the discharge cells; and
first and second electrodes arranged between the first and second substrates in a direction intersecting the address electrodes to face each other to form discharge gaps in the discharge cells;
wherein each of the first and second electrodes comprises:
at least a pair of lines and a connection line adapted to connect the pair of lines separated from each other by predetermined intervals; and
a protrusion protruding from an intersection of the connection line and the lines.

12. The PDP of claim 11, wherein each of the first and second electrodes comprises a first line arranged near the edge of the discharge cell and a second line arranged near the central portion of the discharge cell, and wherein the protrusion protrudes from the second line toward the first line.

13. The PDP of claim 11, wherein the protrusion portion has an angled or rounded shape.

14. A Plasma Display Panel (PDP), comprising:
first and second substrates facing each other;
address electrodes arranged between the first and second substrates;
barrier ribs arranged between the first and second substrates to define a plurality of discharge cells;
phosphor layers arranged on inner surfaces of the discharge cells; and
first and second electrodes arranged between the first and second electrodes in a direction intersecting the address electrodes to face each other to form discharge gaps in the discharge cells;
wherein each of the first and second electrodes comprises at least three lines separated from each other by predetermined intervals; and
wherein sizes of first gaps between pairs of lines arranged near central portions of the discharge cells are different from sizes of second gaps between pairs of lines arranged near edges of the discharge cell.

15. The PDP of claim 14, wherein the second discharge gaps are larger than the first discharge gaps; and wherein the second discharge gaps are disposed along central lines of the discharge cells.
